(19) United States
(12) Patent Application Publication
(10) Pub. No.: US 2010/0202889 A1
(43) Pub. Date: Aug. 12, 2010

(54) METHOD FOR PRODUCING A LIGHTWEIGHT TURBINE BLADE

(75) Inventors: Hermann Klingels, Dachau (DE); Albin Platz, Ried-Baindlkirch (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/447,239

(22) PCT Filed: Oct. 17, 2007
(86) PCT No.: PCT/DE2007/001860

§ 371 Date: Apr. 30, 2010

(30) Foreign Application Priority Data
Oct. 26, 2006 (DE) 10 2006 050 440.2

(51) Int. Cl. F01D 5/14; B23H 9/10; B22D 31/00

(52) U.S. Cl. 416/223 A; 164/70.1

(57) ABSTRACT

A method for producing a lightweight turbine blade for a gas turbine is disclosed. In an embodiment, the method includes casting of a blade element with a blade wall and at least one cavity enclosed by the blade wall. The blade wall is at least partially reduced in thickness by machining after the casting. This provides a method for producing a blade element, in which the wall thickness of the blade wall can be adapted to the mechanical load of the blade element, and the weight of the blade element can be reduced at the same time.

### BACKGROUND AND SUMMARY OF THE INVENTION

This application claims the priority of International Application No. PCT/DE2007/001860, filed Oct. 17, 2007, and German Patent Document No. 10 2006 050 440.2, filed Oct. 26, 2006, the disclosures of which are expressly incorporated by reference herein.

The present invention relates to a method for producing a lightweight turbine blade for a gas turbine, which has at least one cavity (2), wherein the method comprises at least a casting of a blade element (1) with a blade wall and at least one cavity (2) enclosed by the latter. The invention relates further to a blade element, which is produced with the method according to present invention.

A method for producing a blade element for a gas turbine is known from European Patent Specification EP 1 052 370 B1, wherein the blade element is produced by means of a casting process. The method described therein comprises a fabrication of matched, flow-related surfaces on integral bladed rotor units. In this case, the method relates to the production of new parts and can be used on the entire surface of the blade including its transition to adjacent components. The method relates further to joints, which result from welding, adhesion, soldering or another joining method, and require subsequent machining, for example by material removal. Thus, the method described herein provides for removing allowances that are caused by welding, for example, and adapting to the target contour of the blade element surface.

The known methods for producing blade elements for high, medium and low-pressure turbine stages of gas turbines comprise for the most part a precision casting method, wherein the blade elements are produced from Ni-based or Co-based alloys. If, during operation, the gas temperatures of the gas turbine lie above permissible material temperatures, the blades are embodied as hollow blades through which a cooling medium is conducted, which exits from cooling ducts that are provided in the blade wall of the blade element. On the other hand, uncooled blades are cast to some extent as solid blades and to some extent also as hollow blades because of mechanical requirements and for weight reasons. In the design of the guide blades, individual blades, which are used for the most part for high-pressure turbines, differ from blades from medium-pressure turbines and low-pressure turbines, which are designed in segments having several aerodynamic profiles and an inner and an outer cover band. However, in the case of moving blades, there are designs without an outer cover band, which are preferably used with high-pressure turbines. The moving blades having an outer cover band are preferably used in medium-pressure turbines and low-pressure turbines.

During the casting process, the problem frequently arises that the minimum thicknesses of the blade wall of 0.8 mm to 1.0 mm cannot be fallen short of. Even the minimum thicknesses of the blade rear edges are limited in terms of the minimum thickness to approx. 0.6 mm to 0.8 mm.

The average stress due to the load of centrifugal force in any cross section of the blade element depends upon the radial position of the sectional plane, the cross sectional surface being observed and the load of the centrifugal force from the blade part that lies radially outside the sectional plane. The further the intended intersecting line is displaced outward, the lower the load of the centrifugal force of the then remaining blade region is and the lower the stress level that forms in the case of the given cross-sectional surface.

However, in the case of blade elements that include a cavity, the minimum wall thickness that is realizable through casting technology is fixed. From a mechanical-dynamic view, the wall thickness could be considerably lower in many regions of the blade element, however. A reduction in the wall thickness would be advantageous in particular in the radially outer region. A substantial weight reduction of the blade elements can be achieved through lower wall thicknesses in the case of blade elements having a cavity in regions which are not fully loaded with respect to their mechanical load capacity. The weight reduction in this case is not just to be seen in the reduced blade weight, but also in the resulting reduction in the load of the centrifugal force of the disks on which the blade elements are arranged, and the reduced requirement for the gas turbine housing.

The efficiency of gas turbines is determined by the thickness of the blade rear edges, among other things. With the exception of the locally narrowly limited locations in the vicinity of the cover bands, the blade rear edges are often not very highly loaded mechanically. A reduction in the wall thickness of the blade elements of 0.1 mm, for example, may produce an improvement in efficiency of approx. 0.1%.

As a result, the objective of the present invention is creating a method for producing a blade element for a gas turbine, in which the thickness of the blade wall can be adapted to the mechanical load of the blade element, and the weight of the blade element can be reduced at the same time.

The invention includes the technical teaching that the blade wall is at least partially reduced in thickness by machining after the casting process. The advantage of this is that the minimum wall thickness of the blade wall is not limited to the minimum wall thickness required for a stable casting process. The blade wall, which in terms of the present invention extends over the entire cross section of the blade element provided with a cavity, and thus also includes the blade rear edge, can be reduced by machining after the casting process in order to adapt this to a optimum mechanical load. The machining in this case can be limited to parts of the surface of the blade wall so that only individual regions in the blade wall can be reduced in terms of thickness. This can take place contiguously, wherein the individual regions may also be processed separately from one another at different locations.

According to a further advantageous embodiment of the method, the thickness of the blade wall is reduced by a material removal process. The material removal process in this case may comprise an EDM method, an ECM method and/or a PECM method. Electrochemical processing methods are suitable especially for processing high-temperature turbine materials, which are comprised of Ni-based or Co-base alloys and are difficult to machine. A preferred variant of the electrochemical material removal process can be seen in electric discharge machining, in which electrodes are formed on the to-be-produced target contour, whose shaping can be represented in the desired blade wall of the blade element. The PECM method describes a so-called pulsed electrochemical machining, and describes a newer electrochemical material removal process that uses a pulsed current. This method can be considered especially suitable for the present application case.

It is provided according to another advantageous embodiment of the present invention that the blade wall in this method be cast at least partially with a machining allowance, and wherein the machining allowance is removed by the machining and after machining has the finished dimension. The machining allowance can be selected to be as great as desired, however, it is advantageous to provide the machining allowance at least in the head region of the blade element with the minimum blade wall thickness that can be produced with the casting technology so as not to unnecessarily prolong the duration of machining by the material removal process.

It can be provided that the blade element be cast with a machining allowance over the entire blade wall, and a locally different material thickness be removed from the blade wall by the subsequent material removal process. The material removal does not have to be restricted to the regions of the blade element, in which the minimum blade wall thickness from the casting technology is supposed to be fallen short of by the material removal process. It is also conceivable that, to avoid changes in curvature in the surface of the blade wall and to avoid steps from arising, the entire surface of the blade element is provided with a machining allowance in order to subsequently remove all regions. In this case, material removal can turn out to be locally different. Also with respect to a uniform surface over the entire blade wall, removal over the entire outer side of the blade element is advantageous.

With respect to the geometry of the blade element, the element extends radially from an inner foot region into an outer head region, wherein the to-be-removed machining allowance is applied in the head region during the casting process. The to-be-removed machining allowance arises during production through a thickness of the blade wall, which describes the minimum wall thickness that can be produced by the casting technology. For static, dynamic reasons a reduction in the thickness of the blade wall in the head region is especially advantageous because the centrifugal forces no longer occur here at the same level as in the foot region of the blade element. Because of the material removal in the head region of the blade element and thus because of the reduction in mass, the occurring centrifugal forces are reduced in turn in the foot region of the blade element. The minimum wall thicknesses achievable through the casting technology in the foot region of the blade element are utilized mechanically in this case, and do not have to be reduced further.

With regard to the axial extension of the blade element, the geometry of the blade element can be described by an axially forward profile nose region culminating in a rear profile rear edge region. It is provided in this case, that the to-be-removed machining allowance is applied in the profile rear edge region during the casting process. An overall observation of the blade element makes clear that the to-be-removed region essentially extends from the head region passing into the profile rear edge region, and the foot region passing into the profile nose region does not have any metal removal.

In the case of an advantageous embodiment, the to-be-removed regions over the surface of the blade element can also be determined in that the regions have locally different material thicknesses and the to-be-removed material thickness is adapted to the thermal stress that is minimally forming in the material of the blade wall. The distribution of the material thickness of the blade wall after the removal process features a distribution, which produces minimum thermal stress during operation of the blade element. Especially in the case of wall-cooled blades, the material distribution can be optimized for minimum thermal stress. This results in an improved cooling, which at the same time produces an extension in the service life of the blade elements.

A further advantageous embodiment provides for a surface structure to be realized in the blade wall by the material removal process. This can occur, for example, in that the formed electrode tool with the ECM method or the PECM method has the negative of the surface structure, which is introduced into the blade wall during the method. An increase in efficiency can be achieved by a structure deviating from a smooth surface being realized particularly in the region of the profile rear edge for reasons related to flow optimization and positively influencing the flow boundary layer in surface-adjacent regions of the blade wall. For example, structured surfaces according to the principle of a shark-skin or even according to the principle of controlled flow separation are mentioned in this case.

According to a further advantageous embodiment of the inventive method, the casting of the cavity is performed with a core mold and the material removal process performed by means of at least one formed electrode tool, wherein the formed electrode tool is aligned according to the core or the cavity produced by the core in order to minimize the wall thickness tolerances in the blade wall.

A further advantageous embodiment of the invention provides that the blade element undergo a thermal treatment comprised of a HIP method prior to the material removal process. The HIP method describes a hot isostatic pressing of the material of the blade element in order to prevent the exposing of any blowholes and pores that may possibly be present in the casting.

The present invention also relates to a blade element which is produced with the described method. The blade element has in regions a blade wall treated by means of a material removal process, wherein the blade wall has at least in regions a thickness of 0.2 mm to 0.7 mm, preferably of 0.4 mm to 0.6 mm and especially preferably of 0.5 mm. These orders of magnitude are not achievable just like that by means of a precision casting method or a MIM method, which stands for metal injection molding method. The blade element according to the present invention is characterized by wall thicknesses, which lie considerably below the minimum wall thicknesses that can be realized with the cited casting technology.

The thickness of the blade wall diminishes advantageously from the foot region into the head region, wherein the minimum wall thickness in the head region is 0.3 mm to 0.6 mm, preferably 0.4 mm to 0.5 mm and especially preferably 0.45 mm. With respect to the axial extension of the blade wall, this diminishes in terms of thickness from the profile nose region into the profile rear edge region, wherein the minimum wall thickness in the profile rear edge region is 0.2 mm to 0.5 mm, preferably 0.3 mm to 0.45 mm and especially preferably 0.4 mm. The surface of the blade element in the regions in which the thickness of the blade wall falls short of a thickness of 0.6 mm to 0.8 mm, has a surface processed with an ECM and/or with a PECM method.

### BRIEF DESCRIPTION OF THE DRAWINGS

Additional measures improving the invention are explained in greater detail on the basis of the figures in the following along with the description of a preferred exemplary embodiment of the invention.

The drawings show:

FIG. 1 is a side view of a blade element, which has a surface processed in regions by means of a material removal process;

FIG. 2 is a depiction of a first cross section of the blade element according to FIG. 1 taken along line II-II in FIG. 1, wherein the position of the cross section lies in the foot region of the blade element; and

FIG. 3 is a depiction of a second cross section of the blade element according to FIG. 1 taken along line III-III in FIG. 1, wherein the position of the cross section lies in the head region of the blade element.

### DETAILED DESCRIPTION OF THE DRAWINGS

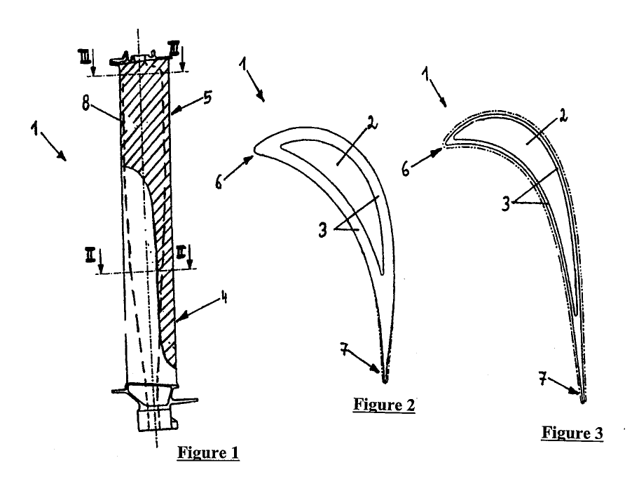

FIG. 1 shows a blade element, which is provided with reference number 1. The blade element 1 is depicted in a side view, in which the radial extension of the blade element 1 lies in the vertical and the axial extension in the horizontal. Therefore, the lower region of the blade element 1 is identified with the foot region 4 and the upper region with the head region 5. The region of the blade element 1, which is processed by means of a material removal process after the casting method, is indicated by a cross-hatched region. Thus, the cross-hatched region extends over the head region 5 into the foot region 4, wherein in the head region 5, the entire width of the blade element 1 is processed in the axial direction, whereas in the foot region 4 only the profile rear edge region 7 is processed. Therefore, the profile nose region 6 in the foot region 4 is not processed. A dashed line indicates the core mold 8, which is produced for the creation of the cavity (not visible in FIG. 1) within the blade element 1. The view of the cross section from FIG. 2 is indicated by a sectional plane II-II, wherein the cross-sectional view according to FIG. 3 is indicated by the sectional plane III-III in the head region 5 of the blade element 1.

FIG. 2 depicts the cross section of the blade element 1 in the cross-sectional plane II-II. Evident in this depiction is the cavity 2, through which cooling air is introduction during operation into the blade element 1, which is fed through cooling bore holes (not shown) within the blade wall 3 for cooling the outer side of the blade wall 3. The profile nose region that is axially situated against the flow direction is indicated by the reference number 6 so that the blade element 1 extends into the profile rear edge region according to reference number 7. With a view of FIG. 1, a material removal process is executed in the sectional plane II-II only in the profile rear edge region 7. The wall thickness of the blade wall 3 that is reduced by means of the material removal process in the profile rear edge region 7 is indicated by a dashed and dotted line. The dashed and dotted line represents the cross section of the blade element 1 produced by means of the casting process, wherein the continuous line in the region of the blade rear edge represents the finished contour of the blade element 1 after the material removal process.

FIG. 3 depicts the blade element 1 in cross section, wherein the sectional plane with a view of FIG. 1 in plane III-III lies in the head region 5 of the blade element 1. In FIG. 3 reference number 6 also designates the profile nose region and reference number 7 designates the profile rear edge region, between which the blade wall 3 extends. Compared to the cross section according to FIG. 2, the cavity 2 extends over a larger region of the cross section of blade element 1, wherein the wall thickness of the blade wall 3 is considerably smaller than in the cross section according to FIG. 2. The minimum cross section of the blade wall 3 realizable with the casting technology is represented by the dashed and dotted line, which extends over the entire outer surface of the blade wall 3 and encloses the entire surface of the outer side of the blade element 1 in the head region 5. The entire outer region of the blade wall 3 is now removed by means of the material removal process so that the minimum wall thickness that can be realized with the casting technology is further reduced over the entire cross section of the blade element 1. The minimum wall thickness, which lies considerably below 0.8 mm, is represented by the solid body line and describes the finished shape of the blade element 1.

The invention is not limited in terms of its design to the exemplary embodiment disclosed in the foregoing. In fact, a number of variants are conceivable, which makes use of the described solution even in the case of fundamentally different designs.

1-16. (canceled)

17. A method for producing a lightweight turbine blade for a gas turbine, comprising the steps of:
casting of a blade element with a blade wall and a cavity enclosed by the blade wall; and
at least partially reducing a thickness of the blade wall by machining after the casting step.

18. The method according to claim 17, wherein the thickness of the blade wall is reduced by an ECM and/or a PECM method.

19. The method according to claim 17, wherein the machining is an EDM method and wherein a developing recast layer is removed mechanically by barrel finishing or abrasive flow machining or by ECM/PECM.

20. The method according to claim 17, wherein during the casting the blade wall is cast at least partially with a machining allowance, wherein the machining allowance is removed by the machining, and wherein after the machining the blade wall has a finished dimension.

21. The method according to claim 17, wherein the blade element extends radially from an inner foot region into a radially outer head region, and wherein a machining allowance is applied in the head region during the casting.

22. The method according to claim 17, wherein the blade element extends axially from a forward profile nose region to a rear profile rear edge region, and wherein a machining allowance is applied in the rear profile rear edge region during the casting.

23. The method according to claim 17, wherein the blade element is cast with a machining allowance over the entire blade wall, and wherein a locally different material thickness is removed from the blade wall by the machining.

24. The method according to claim 23, wherein the locally different material thickness is adapted by the machining to a thermal stress that is minimally forming during operation of the blade element within the blade wall.

25. The method according to claim 17, wherein a surface structure is realized in the blade wall by the machining.

26. The method according to claim 17, wherein the casting of the cavity is performed with a core mold and wherein the machining is performed by at least one formed electrode tool in order to minimize wall thickness tolerances in the blade wall.

27. The method according to claim 17, wherein the blade element undergoes a thermal treatment comprised of a HIP method prior to the machining.

28. A blade element for a gas turbine, which is produced with a method according to claim 17.

29. The blade element according to claim 28, wherein the blade wall has at least in regions a thickness of 0.2 mm to 0.7 mm.

30. The blade element according to claim 28, wherein the thickness of the blade wall diminishes from a foot region into a head region and wherein a minimum wall thickness in the head region is 0.3 mm to 0.6 mm.

31. The blade element according to claim 28, wherein the thickness of the blade wall diminishes from a profile nose region into a blade rear edge region and wherein a minimum wall thickness in the blade rear edge region is 0.2 mm to 0.5 mm.

32. The blade element according to claim 28, wherein regions of the blade wall with a thickness of less than 0.6 mm to 0.8 mm have a surface processed by an ECM and/or a PECM method.

33. A turbine blade for a gas turbine, comprising:
a cast blade element including a blade wall and a cavity enclosed by the blade wall;
wherein a thickness of at least a portion of the blade wall is reduced by machining after the blade element is cast;
wherein the thickness of the blade wall diminishes from a foot region into a head region and wherein a minimum wall thickness in the head region is 0.3 mm to 0.6 mm;
and wherein the thickness of the blade wall diminishes from a profile nose region into a blade rear edge region and wherein a minimum wall thickness in the blade rear edge region is 0.2 mm to 0.5 mm.
